(19) United States
(12) Patent Application Publication
(10) Pub. No.: US 2025/0365374 A1
(43) Pub. Date: Nov. 27, 2025

(54) IMAGE INSPECTION SYSTEM, IMAGE INSPECTION APPARATUS, IMAGE INSPECTION METHOD, AND RECORDING MEDIUM

(71) Applicant: Konica Minolta, Inc., Tokyo (JP)

(72) Inventor: Yasumasa TSUKAMOTO, Tokyo (JP)

(21) Appl. No.: 19/202,579

(22) Filed: May 8, 2025

(30) Foreign Application Priority Data
May 27, 2024 (JP) 2024-085385

(51) Int. Cl. H04N 1/00

(52) U.S. Cl. CPC H04N 1/00005; H04N 1/00015; H04N 1/00034; H04N 1/0005; H04N 1/00082; H04N 1/0009

(57) ABSTRACT

An image inspection system includes a hardware processor that generates a reference image to be used for inspecting an image formed on a recording medium and performs inspection of an inspection target image generated by reading the image formed on the recording medium on the basis of the reference image. The hardware processor controls not to perform the inspection on the basis of a predetermined state occurring in a process of generating the reference image.

### CROSS-REFERENCE TO RELATED APPLICATION

Japanese patent application No. 2024-085385 filed on May 27, 2024, including description, claims, drawings, and abstract the entire disclosure is incorporated herein by reference in its entirety.

### BACKGROUND OF THE INVENTION

### 1. Technical Field

The present invention relates to an image inspection system, an image inspection apparatus, an image inspection method, and a recording medium.

### 2. Description of Related Art

Conventionally, a method for inspecting the quality of a printed product by comparison between a reference image and a read image obtained by reading a printing sheet (printed product) on which an inspection image is printed has been known (for example, Japanese Unexamined Patent Application Publication No. 2016-146514). In Japanese Unexamined Patent Application Publication No. 2016-146514, a read image of a printed product which is inspected by a user and which is determined to have no abnormality among several printed products having inspection images printed thereon is used as a reference image.

In addition, a method for inspecting the quality of a printed product by comparison between a document image which is used as a reference image and a read image obtained by reading a printed product has also been known (for example, Japanese Unexamined Patent Application Publication No. 2015-53561).

### SUMMARY OF THE INVENTION

However, an image forming apparatus disclosed in Japanese Unexamined Patent Application Publication No. 2016-146514 requires a user to perform inspection work in order to generate a reference image to be used for main printing. Furthermore, it is necessary to execute the main printing after a reference image is prepared before the start of the main printing. In addition, a printed product inspection device disclosed in Japanese Unexamined Patent Application Publication No. 2015-53561 needs to complete the generation of a reference image (steps S101 to S115 in FIG. 6) before the generation of an inspection image (step S117 in FIG. 6) is started. Therefore, there is a problem that considerable time is still required for the processing from the generation of the reference image (steps S101 to S115 in FIG. 6) to the image inspection (steps S117 to S119 in FIG. 6).

On the other hand, a technology for performing processing of generating the reference image and processing of inspecting the inspection image in parallel at the same time has not been proposed so far. In order to shorten the time required for the processing from the generation of the reference image to the image inspection, the present inventor has been developing a technology for simultaneously performing processing of generating a reference image and processing of inspecting an inspection image in parallel and sequentially performing image inspection using the reference image that has been generated. However, in the process of generating the reference image, for example, an abnormal state such as a state in which a storage area for storing the reference image cannot be reserved may occur. That is, an abnormal state in the process of generating the reference image can be a factor that prevents the execution of normal image inspection.

The present invention has been made in view of the above-mentioned circumstances. An object of the present invention is to provide an image inspection system, an image inspection apparatus, an image inspection method, and a non-transitory computer-readable recording medium storing an image inspection program with which it is possible to prevent or suppress an occurrence of a situation in which an inspection is performed without being ready for the inspection of an inspection image due to an abnormal state in a process of generating a reference image.

To achieve at least one of the abovementioned objects, according to an aspect of the present invention, an image inspection system reflecting one aspect of the present invention comprises the followings.

An image inspection system including
a hardware processor that generates a reference image to be used for inspecting an image formed on a recording medium and performs inspection of an inspection target image generated by reading the image formed on the recording medium on the basis of the reference image,
in which the hardware processor controls not to perform the inspection on the basis of a predetermined state occurring in a process of generating the reference image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic block diagram of a printing system according to an embodiment of the present invention;

FIG. 2 is a schematic block diagram illustrating a configuration of an image forming system illustrated in FIG. 1;

FIG. 3 is a block diagram for describing the outline of a control operation of a controller and a print controller illustrated in FIG. 2;

FIG. 4 is a flowchart illustrating a processing procedure of an image inspection method performed by the image forming system illustrated in FIG. 1;

FIG. 5 is a subroutine flowchart illustrating the detail of processing procedure (step S102) of forming and inspecting an inspection image illustrated in FIG. 4; and

FIG. 6 is a schematic diagram illustrating, in a time-series manner, processing of acquiring a document image, processing of generating a reference image, processing of forming an inspection image, and processing of inspecting the inspection image.

### DETAILED DESCRIPTION

Hereinafter, one or more embodiments of the present invention will be described with reference to the drawings. However, the scope of the invention is not limited to the disclosed embodiments. Note that in the description of the drawings, the same components are denoted by the same reference signs, and redundant descriptions will not be repeated. In addition, dimensional ratios in the drawings are exaggerated for convenience of description and may be different from actual ratios.

### Embodiment

### <Configuration of Printing System>

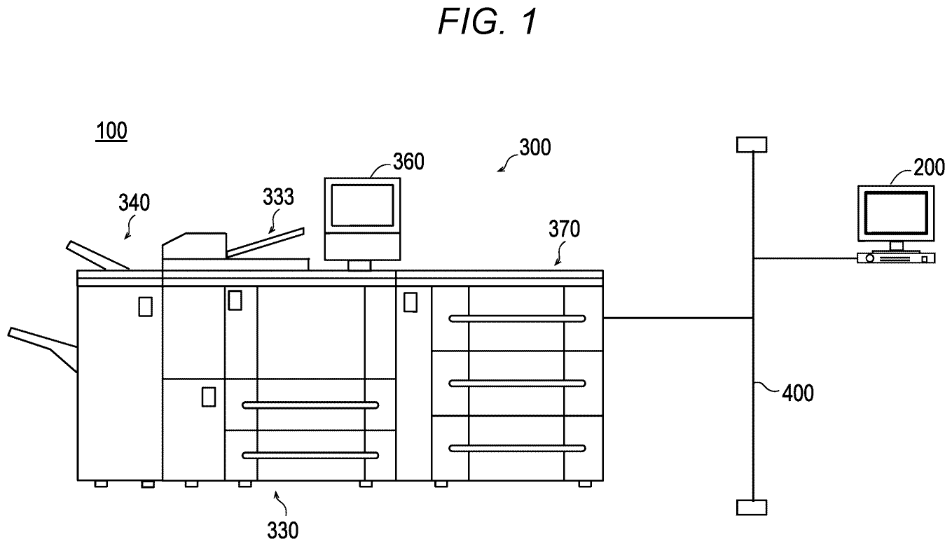

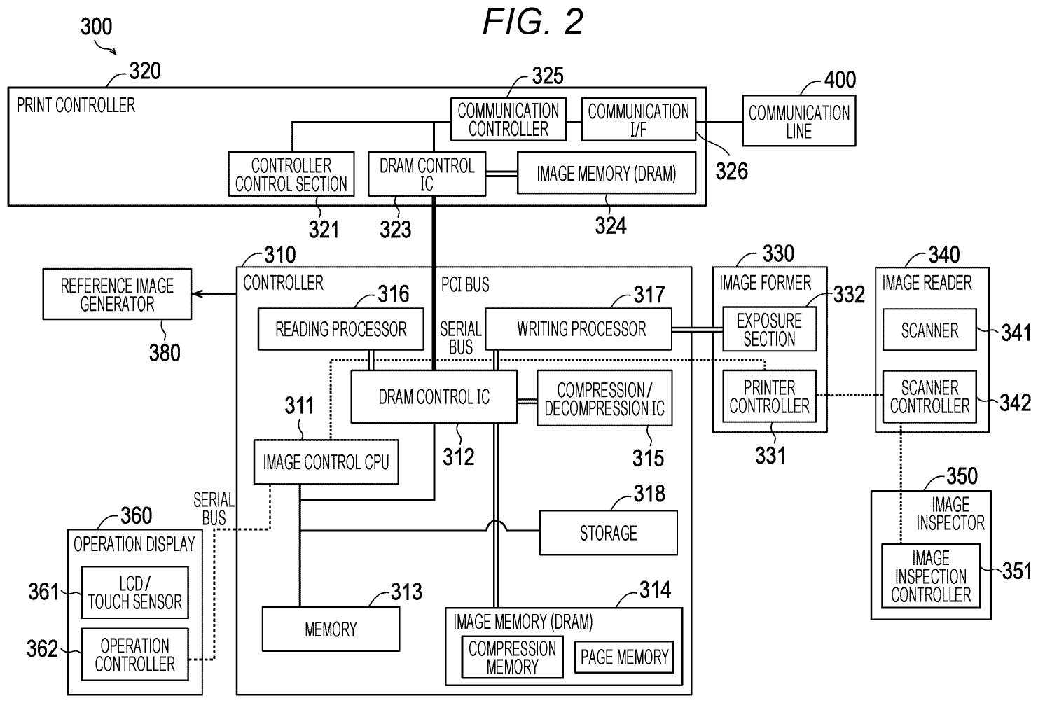

FIG. 1 is a schematic block diagram of a printing system according to an embodiment of the present invention, and FIG. 2 is a schematic block diagram illustrating the configuration of an image forming system illustrated in FIG. 1.

As illustrated in FIG. 1, a printing system 100 includes a client terminal 200 and an image forming system 300. The client terminal 200 and the image forming system 300 are communicably connected to each other via a communication line 400.

The client terminal 200 may be, for example, a personal computer, a tablet terminal, a smartphone, or the like. A printer driver for converting document data into a print job is installed in the client terminal 200. The printer driver generates a print job in a format compatible with a print controller 320 (see FIG. 2) of the image forming system 300, and transmits the print job to the image forming system 300 via the communication line 400. The client terminal 200 includes a display, and can display a result (indicating a non-defective product or a defective product) of inspecting a printed product, an image of a defective printed product, and the like.

The print job includes, for example, print data in a page description language (PDL) format and job information. The print data includes, for example, print data of the first to n-th pages. The job information includes, for example, print settings such as the number of pages, the number of copies, the type of a sheet (recording medium), the size of the sheet, the basis weight of the sheet, single-sided printing or double-sided printing, and an inspection setting (on or off). A user can instruct the image forming system 300 to perform image inspection by turning on the inspection setting.

The communication line 400 may include a local area network (LAN) in which computers and network devices are connected to each other according to a predetermined standard, a wide area network (WAN) in which LANs are connected to each other by a dedicated line, or the like. The predetermined standard is, for example, Ethernet (registered trademark), fiber distributed data interface (FD DI), wireless fidelity (Wi-Fi), or the like.

Note that the number of the above constituent elements connected to the communication line 400 is not limited to that in the case illustrated in FIG. 1.

### <Configuration of Image Forming System 300>

As illustrated in FIGS. 1 and 2, the image forming system (image inspection system) 300 includes a controller 310, a print controller 320, an image former 330, an image reader 340, an image inspector (image inspection apparatus) 350, an operation display 360, a sheet feeder 370, and a reference image generator 380. The image forming system 300 functions as an image inspection system.

### <Configuration of Controller 310>

The controller 310 includes an image control central processing unit (CPU) 311, a dynamic random access memory (DRAM) control IC 312, a memory 313, an image memory (DRAM) 314, a compression/decompression IC 315, a reading processor 316, a writing processor 317, a storage 318, and the like.

The image control CPU 311 develops various programs stored in the storage 318 in the memory 313, and comprehensively controls the operation of the entire image forming system 300 in cooperation with the developed programs.

The reading processor 316 performs various kinds of processing such as analog processing, A/D conversion processing, and shading processing on an analog image signal output from a scanner 341 of the image reader 340, and generates digital image (read image) data. The generated digital image data is output to the compression/decompression IC 315 by the DRAM control IC 312. Under the control of the DRAM control IC 312, the compression/decompression IC 315 performs compression processing on digital image data and decompression processing on the digital image data that has been subjected to the compression processing. Furthermore, the DRAM control IC 312 controls input and output of the digital image data subjected to the compression and decompression processing to and from the image memory (DRAM) 314.

The image memory 314 is composed of DRAM and includes areas of a compression memory and a page memory therein to temporarily store compressed image data, decompressed image data, and the like. The controller 310 performs control to reserve a first storage and a second storage in the page memory before execution of the inspection by the image inspector 350. Memory address spaces of the first storage and the second storage in the image memory 314 are managed by the image control CPU 311. The controller 310 can be configured to estimate the data sizes of the reference image and the read image based on the print data, and allocate the first storage and the second storage having sizes corresponding to the estimated data sizes of the reference image and the read image to the image memory 314. The reference image and the read image are stored in the reserved first storage and second storage, respectively. The image memory 314 functions as a storage device.

The first storage is an area for storing the reference image generated by the reference image generator 380. In particular, in the present embodiment, the first storage stores the reference image that is currently generated by the reference image generator 380 during the generation of an inspection target image. The inspection target image is a read image obtained by reading an inspection image formed on a sheet by the image reader 340. In the present embodiment, the term “during generation of an inspection target image” refers to a period including not only the generation of a read image by the image reader 340 but also the formation of an inspection image on a sheet by the image former 330. The inspection target image is stored in the second storage.

For example, when storing the reference image in the first storage, the controller 310 stores, in the first storage, information regarding the page (e.g., page number) of the corresponding inspection image in association with the reference image. The controller 310 has a function of determining whether or not a reference image corresponding to the inspection image is stored in the first storage by referring to the page-related information in the first storage. For example, the controller 310 can determine whether or not a reference image corresponding to the inspection image is stored in the first storage at a determination timing immediately before the inspection of the inspection image, and can output the determination result. Further, the controller 310 can determine whether or not the inspection image is stored in the second storage at the determination timing immediately before the inspection of the inspection image, and can output the determination result. The determination timing is not limited to a timing immediately before the execution of the inspection. The controller 310 may be configured to determine whether or not the inspection image and the reference image corresponding to the inspection image have been stored at any determination timing in an image forming process from the start of image formation of the inspection image to the completion of the image formation or a reading process from the start of reading of the inspection image to the completion of the reading.

Further, the controller 310 functions as a first deletion section and can delete the reference image stored in the first storage page by page based on the completion of the inspection for each page by the image inspector 350. Further, the controller 310 functions as a second deletion section and can delete the inspection target image stored in the second storage page by page based on the completion of the inspection for each page by the image inspector 350.

### <Configuration of Print Controller 320>

The print controller 320 analyzes the print job received from the client terminal 200 via the communication line 400, performs processing such as color conversion, screening, and rasterization, and generates a document image in a bitmap format. The generated document image is transmitted to the controller 310. The print controller 320 functions as a job acquirer.

The print controller 320 includes a controller control section 321, a DRAM control IC 323, an image memory (DRAM) 324, a communication controller 325, and a communication interface (I/F) 326. The controller control section 321 comprehensively controls the operation of each section of the print controller 320. Further, the controller control section 321 receives the print job from the client terminal 200 or the like via the communication I/F 326. The communication controller 325 controls the communication I/F 326.

The received print job includes print data serving as a source of a document image and job information in which print settings such as the type of a sheet to be used are described. The print data is mainly in a PDL format. The print controller 320 performs rasterization (RIP) processing for converting print data into bitmap data in units of pages based on the print settings.

The RIP image that has been subjected to the rasterization processing is temporarily stored in the image memory 324. The RIP image in the image memory 324 is temporarily stored in a compression memory region in the image memory 314 via the compression/decompression IC 315 under the control of the DRAM control IC 323 of the print controller 320 and the DRA M control IC 312 of the controller 310. At the time of normal printing, the RIP image stored in the compression memory region is decompressed by the compression/decompression IC 315 and is transmitted to the image former 330 as a document image (image data) via the writing processor 317, and the transmitted RIP image is printed.

The writing processor 317 outputs the decompressed digital image data to an exposure section 332 of the image former 330.

In the present embodiment, the controller 310 can perform control to reserve the first storage and the second storage in the image memory 314 based on, for example, the acquisition of the print job. More specifically, the controller 310 allocates regions of the first storage and the second storage to the image memory 314 at a timing at which the controller control section 321 acquires a print job. Alternatively, the process of generating the reference image may include a process of reserving the first storage in the image memory 314.

The controller 310 outputs, at a predetermined generation timing, a reference image generation instruction to the reference image generator 380, which will be described later, to generate a reference image based on the document image. The predetermined generation timing can be, for example, a timing when the inspection setting is on and the job acquirer acquires the document image. The reference image generator 380 generates the reference image based on the reference image generation instruction.

Ideally, a read image generated by reading an inspection image formed on a sheet is considered to match the document image in terms of content. However, when the inspection image formed on the sheet is read by the scanner, an error may occur in the read image with respect to the document image due to various factors such as variations in a conveyance path for the sheet, a reading position shift by the scanner, color reproducibility, and a difference in paper type. An error may also occur in the document image depending on the resolution of reading by the scanner. Therefore, when the read image and the document image are simply compared, an error is highly likely to occur, and it is not realistic to inspect the inspection image by simply comparing the read image with the document image. In view of this, the present embodiment is configured to generate a reference image by performing various kinds of processing on the document image in terms of position, resolution, color, and the like so that the reference image can be compared with the read image, and to compare the reference image and the read image. Thus, the reference image can be appropriately compared with the read image, whereby the printed product can be accurately inspected. The details of the processing of generating the reference image will be described later.

### <Configuration of Image Former 330>

The image former 330 forms (prints) an image on a sheet with an electrophotographic method including processes of charging, exposure, development, transfer, and fixing, in accordance with an instruction from the controller 310. In the present embodiment, the image former 330 forms an inspection image to be inspected by the image inspector 350 on a sheet under an image forming condition set based on the print settings. The image former 330 includes a printer controller 331, the exposure section 332, and the like. The printer controller 331 is connected to the image control CPU 311 by serial communications, and receives control by the image control CPU 311. The printer controller 331 drives a laser diode (LD) of the exposure section 332 in response to a signal from the writing processor 317, and forms an electrostatic latent image corresponding to a document image on a photoreceptor (not illustrated). The toner image formed on the photoreceptor is developed through a development process and is transferred onto a sheet supplied from the sheet feeder 370. Next, the unfixed toner image on the sheet is fixed by being heated and pressurized. The sheet on which the toner image has been fixed is conveyed to the image reader 340.

In addition, the image former 330 includes a printing sheet ejection device that ejects (purges) a sheet (waste sheet) having an inspection image that has been detected as abnormal by the image inspector 350 separately from a sheet on which a normal inspection image has been formed.

### <Configuration of Image Reader 340>

The image reader 340 includes the scanner 341 and a scanner controller 342. The scanner 341 reads a sheet (printed product) conveyed through a conveyance path with, for example, a charge coupled device (CCD) image sensor. The scanner controller 342 controls the scanner so that the scanner reads an inspection image formed on the sheet conveyed from the image former 330 according to a reading instruction from the controller 310. The scanner controller 342 outputs, to the controller 310, a read image obtained by reading the inspection image formed on the sheet.

### <Configuration of Image Inspector 350>

The image inspector 350 inspects a read image (inspection target image) generated by reading an image formed on a sheet based on a reference image. M ore specifically, the image inspector 350 acquires the reference image and the read image, and compares the reference image with the read image page by page to inspect the inspection image formed on the sheet.

The image inspector 350 includes an image inspection controller 351. The image inspection controller 351 includes the image control CPU 311 or a CPU, a RAM, a ROM, and an auxiliary storage device (not illustrated). The function of inspecting an inspection image is implemented by the CPU executing an image inspection program. For example, the image inspection controller 351 calculates a difference (error) in pixel value between the reference image and the read image for each page, and determines the quality of the inspection image according to the magnitude of the difference. The difference can be calculated for each page, each object, or each region. For example, in a case where the difference is calculated for each page, an inspection result indicating “non-defective” is output when the total value of differences between pixels in one page is less than a specified value, and an inspection result indicating “defective” is output when the total value of the differences between the pixels in one page is equal to or more than the specified value. In addition, when the difference is calculated for each object or for each region, an inspection result indicating “non-defective” or “defective” is output according to the total value of differences between pixel values in the selected object or region.

When the result of inspecting the inspection image indicates “non-defective”, the controller 310 determines that the printed product is a non-defective product. When the result of inspecting the inspection image indicates “defective”, the controller 310 determines that the printed product is a defective product.

### <Configuration of Operation Display 360>

The operation display 360 includes a touch screen 361, an operation controller 362, a numeric keypad as hardware keys, a start button, a stop button, and the like. The touch screen includes, for example, a touch sensor and a liquid crystal display (LCD) disposed behind the touch sensor. The operation controller 362 receives input from the touch sensor and the hardware keys and transmits input data to the controller 310. Furthermore, the operation controller 362 receives output data from the controller 310 and displays the output data on the LCD. The operation display 360 is used for input of various settings (e.g., on/off of inspection setting) and instructions (e.g., instruction to start printing) by the user. The operation display 360 is also used to output (display) the state of the image forming system 300, a result (non-defective product or defective product) of inspecting a printed product, an image of a defective printed product, and the like.

### <Configuration of Sheet Feeder 370>

The sheet feeder 370 includes at least one large-capacity sheet tray, and supplies sheets one by one to the image former 330.

### <Configuration of Reference Image Generator 380>

The reference image generator 380 generates a reference image to be used for inspecting an image formed on a sheet on the basis of a document image acquired by the job acquirer and outputs the reference image to the controller 310. The reference image generator 380 can be implemented by a CPU (not illustrated), which is different from the image control CPU 311, executing the image inspection program. Thus, the generation of the reference image and the formation and inspection of the inspection image are performed in parallel. Alternatively, in a case where the image control CPU 311 is a multi-core CPU, the reference image generator 380 may be assigned to a core different from a core for the processing of forming and inspecting the inspection image, and the generation of the reference image and the formation and inspection of the inspection image may be performed in parallel by the different cores.

Note that conventionally, the same CPU has been configured to perform the generation of a reference image and the formation and inspection of an inspection image. Therefore, the CPU performs the formation and inspection of the inspection image after completing the generation of the reference image for each page, so that the generation of the reference image and the formation and inspection of the inspection image cannot be performed in parallel. The present embodiment is configured such that the generation of the reference image and the formation and inspection of the inspection image are performed by the different CPUs, whereby the generation of the reference image and the formation and inspection of the inspection image can be performed in parallel.

In addition, in a case where the document image is complex, a calculation load for generating the reference image may significantly increase. The CPU different from the image control CPU 311 generates the reference image, whereby the calculation load on the image control CPU 311 can be reduced.

### <Outline of Control Operation of Controller 310 and Print Controller 320>

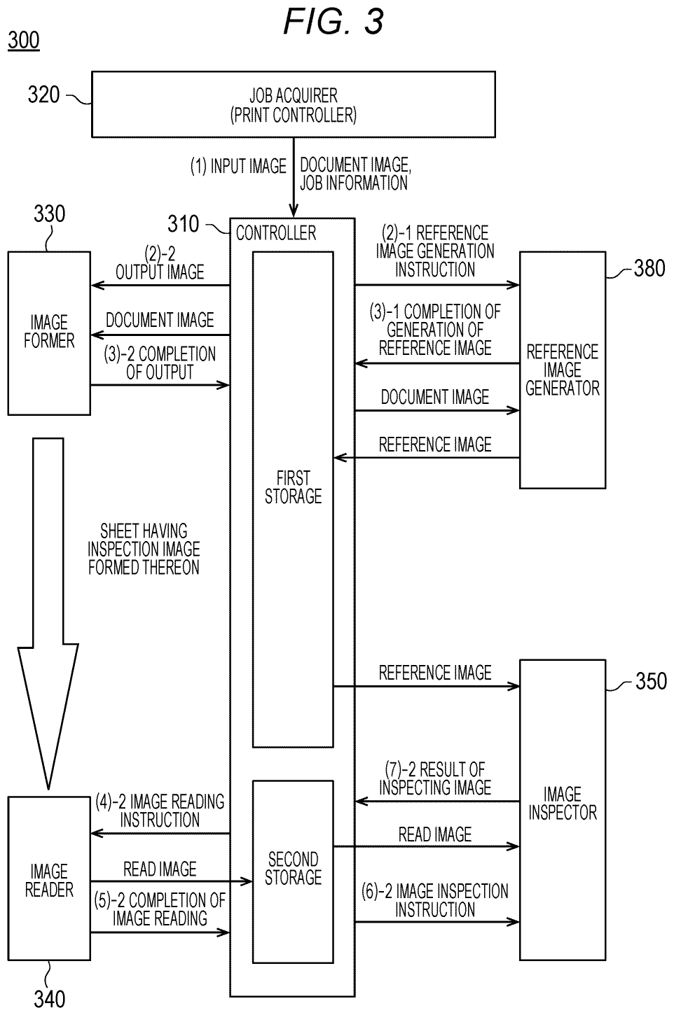

FIG. 3 is a block diagram for describing the outline of a control operation of the controller 310 and the print controller 320 illustrated in FIG. 2.

First, the controller 310 receives a document image and job information from the job acquirer (print controller 320) ((1) input image). The document image is a RIP image obtained by rasterizing print data. The controller 310 stores the document image in the image memory 314. In addition, the controller 310 reserves the first storage and the second storage in the image memory 314.

When receiving a reference image generation instruction from the controller 310 ((2)-1 reference image generation instruction), the reference image generator 380 generates a reference image based on the document image acquired by the job acquirer and outputs the reference image to the controller 310.

As described above, the reference image generator 380 generates the reference image by performing various kinds of processing on the document image in terms of position, resolution, color, and the like. For example, in order that content portions (contents) of the reference image and the read image can be compared with each other, the reference image generator 380 can extract the position information of the content portion from the document image and add or embed the position information to or in the reference image. That is, the reference image generated by the reference image generator 380 includes alignment information for aligning the reference image and the read image when the image inspection is performed based on the reference image. Note that the alignment information includes outline information and edge information of the image. In addition, the reference image generated by the reference image generator 380 has region information regarding an inspection region and an inspection exclusion region used for the image inspection performed based on the reference image. Further, the reference image generator 380 can generate a reference image by adjusting the resolution of the document image so as to match the resolution of the scanner of the image reader 340. Furthermore, the reference image generator 380 can generate a reference image by converting the color space of the document image so as to match the color space (e.g., RGB) adopted by the scanner of the image reader 340.

In addition, upon receiving the document image from the job acquirer, the controller 310 instructs the image former 330 to form an image and outputs the document image stored in the image memory 314 to the image former 330 ((2)-2 output image). In the present embodiment, the image former 330 forms an inspection image on a sheet based on the document image. The generation of the reference image by the reference image generator 380 and the formation of the inspection image by the image former 330 are executed in parallel.

After completing the generation of the reference image, the reference image generator 380 gives a notification indicating that the generation of the reference image has been completed to the controller 310 ((3)-1 completion of generation of reference image). Furthermore, when completing the image formation on the sheet, the image former 330 gives a notification indicating the completion of output to the controller 310 ((3)-2 completion of output). In the present embodiment, the first storage stores the reference image that is currently generated by the reference image generator 380 during the generation of the inspection image. The generated reference image is stored in a storage area for the reference image in the first storage ((4)-1 store reference image).

Further, the controller 310 outputs an image reading instruction to the image reader 340 immediately after receiving the notification indicating the completion of the output ((4)-2 image reading instruction). The image reader 340 reads the sheet on which the inspection image is formed, and outputs the read image on the sheet to the controller 310. The controller 310 stores the read image in the second storage. When completing reading the sheet, the image reader 340 gives a notification indicating that the image reading has been completed ((5)-2 completion of image reading).

The controller 310 receives the notification indicating the completion of the image reading and outputs an image inspection instruction to the image inspector 350 ((6)-2 image inspection instruction). The controller 310 determines, for each page, whether or not a reference image corresponding to the inspection image is stored in the first storage. The image inspector 350 acquires the reference image and the read image from the first storage and the second storage, respectively, and inspects the inspection image by comparing the reference image with the read image. Then, the image inspector 350 outputs the result of inspecting the inspection image to the controller 310 ((7)-2 result of inspecting image).

The controller 310 also receives the inspection result of inspecting the inspection image as a notification indicating the completion of inspection by the image inspector 350. Upon receipt of the notification indicating the completion of inspection, the controller 310 deletes the reference image stored in the first storage and the read image stored in the second storage page by page. The image data in the first storage and the second storage is deleted by the controller 310 performing a memory management operation for releasing the storage areas corresponding to the first storage and the second storage. When the storage area is released, the image data stored in the storage area may be overwritten with “0” or the like, or the original data may remain stored without being overwritten with “0” or the like.

In response to an instruction from the user, the controller 310 performs control such that the result (indicating a non-defective product or a defective product) of inspecting the printed product is displayed on the operation display 360 or the display of the client terminal 200, on the basis of the result of inspecting the inspection image.

### <Image Inspection Method by Image Forming System 300>

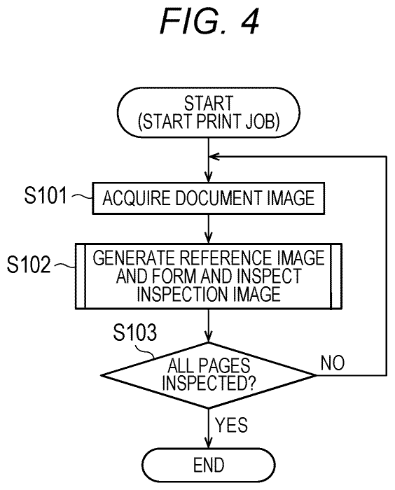

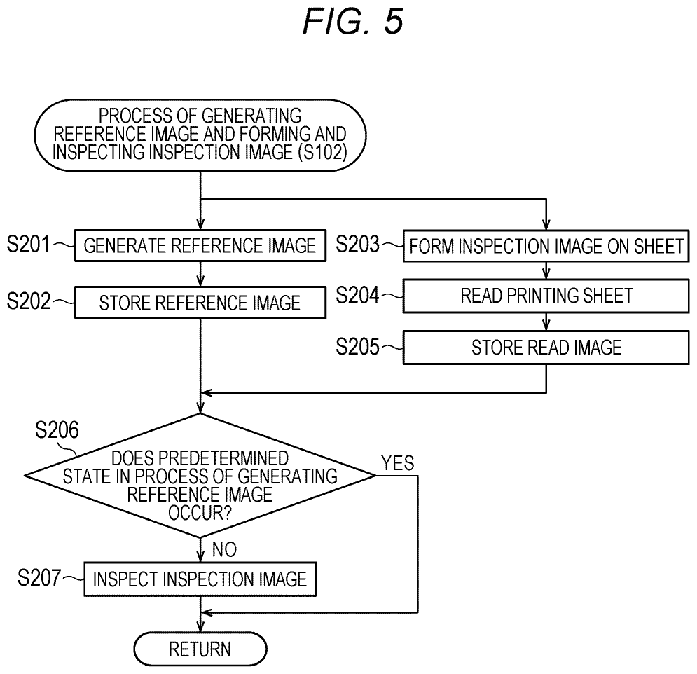

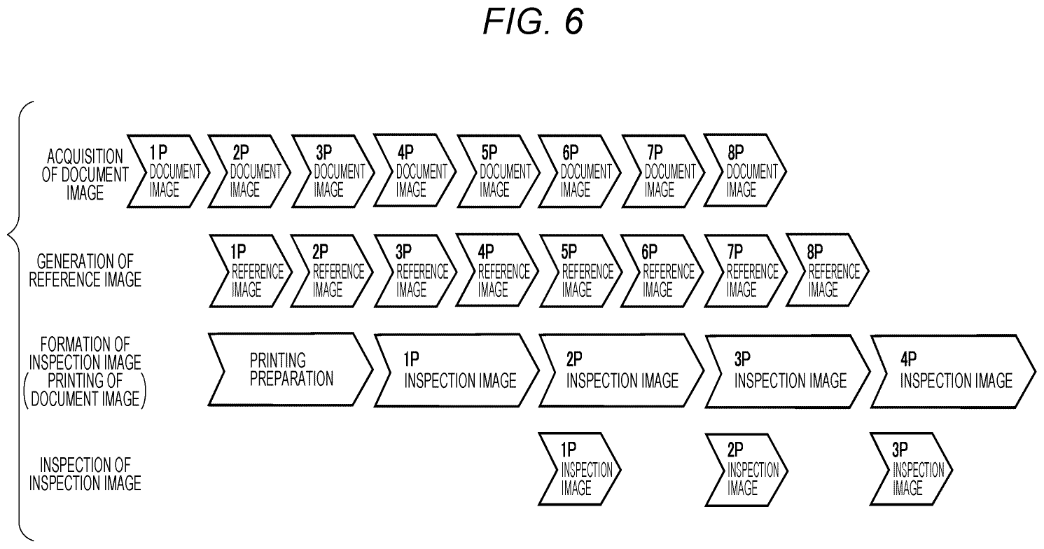

FIG. 4 is a flowchart illustrating a processing procedure of an image inspection method performed by the image forming system illustrated in FIG. 1; FIG. 5 is a subroutine flowchart illustrating the detail of processing procedure (step S102) of forming and inspecting an inspection image illustrated in FIG. 4; and The processing illustrated in FIGS. 4 and 5 is implemented by the image control CPU 311 executing the image inspection program. FIG. 6 is a schematic diagram illustrating, in a time-series manner, processing of acquiring a document image, processing of generating a reference image, processing of forming an inspection image, and processing of inspecting the inspection image.

As illustrated in FIG. 4, first, the controller 310 acquires a document image in step S101. The controller 310 sequentially receives, from the job acquirer, the first page to the last n-th page of the document image (RIP image) page by page in order from the first page to the last n-th page. For example, FIG. 6 illustrates a case where the first to eighth pages of the document image are sequentially received. When the print job is started, the controller 310 stores the document image acquired from the job acquirer page by page in the image memory 314. In addition, the controller 310 reserves the first storage and the second storage in the image memory 314 for each page. When one of the first storage and the second storage cannot be reserved for the page of the acquired document image, the controller 310 releases the other storage and redoes the acquisition of the document image and reserving of the first storage and the second storage.

Next, in step S102, the controller 310 performs a process of generating a reference image and forming and inspecting an inspection image. The reference image generated by the reference image generator 380 is stored in the first storage. The inspection image printed on the sheet by the image former 330 is read by the image reader 340, and the read image is stored in the second storage. The image inspector 350 inspects the inspection image based on the reference image generated by the reference image generator 380 and the read image. The details of the process of step S102 will be described later.

Next, the controller 310 determines whether or not the inspection of all the pages is completed in step S103. When the inspection of all the pages is completed (YES in step S103), the controller 310 ends the processing (end). On the other hand, when the inspection of all the pages is not completed (NO in step S103), the controller 310 returns to the process of step S101.

### <Process of Generating Reference Image and Forming and Inspecting Inspection Image (Step S102)>

As illustrated in FIG. 5, the reference image generator 380 generates the reference image to be used for inspection of the inspection image (step S201). The controller 310 controls the generation of the reference image. The reference image generator 380 generates a reference image in accordance with an instruction from the controller 310. For example, when the first page of the document image is acquired and stored in the image memory 314, the controller 310 controls the reference image generator 380 so that the reference image generator 380 generates the reference image based on the first page of the document image. The reference image generator 380 generates a reference image based on the first page of the document image. A reference image is similarly generated for the second page of the document image.

Next, the first storage stores the reference image generated by the reference image generator 380 (step S202). For example, the first storage stores reference images corresponding to the first page and the second page of the document image.

In parallel with the processes of steps S201 and S202, the controller 310 controls the image former 330 so that the image former 330 forms an inspection image on a sheet based on the document image and the job information received from the job acquirer. In step S203, the controller 310 performs, for example, printing preparation and controls the image former 330 so that the image former 330 forms an inspection image on a sheet based on the first page of the document image. The image former 330 forms an inspection image based on the first page of the document image on a sheet in accordance with an instruction from the controller 310. After the inspection image based on the first page of the document image is formed, an inspection image based on the second page of the document image is similarly formed on the sheet. After the completion of the sheet ejection, the image former 330 gives a notification indicating the completion of the sheet ejection to the controller 310.

Next, in step S204, the controller 310 instructs the image reader 340 to read an image. The image reader 340 reads the inspection image formed on the sheet.

Next, in step S205, the image reader 340 stores the read image obtained by reading the inspection image in the storage area for the read image in the second storage. The image reader 340 gives a notification indicating the completion of reading of the inspection image to the controller 310.

Next, in step S206, the controller 310 determines whether or not a predetermined state in the process of generating a reference image occurs for each page of the acquired document image. That is, the controller 310 determines whether or not the predetermined state in the process of generating the reference image occurs after the image formed on the sheet based on the inspection image is read. When the predetermined state in the process of generating the reference image occurs, the inspection for the inspection image is not ready, so that the controller 310 cannot issue an image inspection instruction to the image inspector 350. Therefore, the image inspector 350 does not inspect (cannot inspect) the inspection image when the predetermined state in the process of generating a reference image occurs. When the predetermined state in the process of generating a reference image occurs (YES in step S206), the controller 310 ends the processing (return). A specific example of the predetermined state in the process of generating a reference image will be described later.

On the other hand, when the controller 310 determines that the predetermined state in the process of generating a reference image does not occur (NO in step S206), the image inspector 350 compares the reference image with the read image to inspect the inspection image (step S207). The image inspector 350 notifies the controller 310 of the inspection result.

As illustrated in FIG. 6, the generation of the reference image by the reference image generator 380 and the formation and inspection of the inspection image by the image former 330 are performed in parallel. Thus, the image forming system 300 can further shorten the time required for the processing from the generation of the reference image to the image inspection as compared with the conventional technology.

### [Generation of Reference Image and Formation of Inspection Image on Sheet to be Performed in Parallel]

For example, in the example illustrated in FIG. 6, the generation of the reference images based on the first page (1P) and the second page (2P) and the printing preparation are executed in parallel, and the generation of the reference image based on the third page (3P) and the formation of the inspection image based on the first page (1P) are executed in parallel. After that, the generation of the reference image based on the fourth page (4P) and the formation of the inspection image based on the first page (1P) are executed in parallel. Note that, although the generation of the reference image based on the third page (3P) and the formation of the inspection image based on the first page (1P) are illustrated as being started at the same time in FIG. 6, it is not limited thereto. The formation of the inspection image based on the first page (1P) can be started at an appropriate timing after the completion of the printing preparation, and the generation of the reference image based on the third page (3P) can be started at an appropriate timing after the generation of the reference image based on the second page (2P).

Regarding the timing of starting the generation of a reference image and the generation of an inspection image, the same applies to the subsequent pages.

### [Generation of Reference Image, Formation of Inspection Image on Sheet, and Inspection of Inspection Image to be Performed in Parallel]

Thereafter, the generation of the reference image based on the fifth page (5P), the formation of the inspection image based on the second page (2P), and the inspection of the inspection image based on the first page are executed in parallel.

As described above, in the present embodiment, while the reference image is generated upon receipt of the document image (the generation of the reference image is triggered by the reception of the document image), the inspection image is formed on the sheet and is inspected when the printing preparation is completed. Furthermore, the generation of the reference image and the formation and inspection of the inspection image are performed in parallel, whereby it is possible to shorten the time required for the processing from the generation of the reference image to the image inspection. As a result, the productivity of a printed product is improved.

Further, the present embodiment performs control so that the inspection by the image inspector is not performed on the basis of the predetermined state occurring in a process of generating a reference image, such as a state in which a storage area for storing the reference image cannot be reserved. Therefore, it is possible to shorten the time required for processing from the generation of a reference image to the image inspection and to prevent or suppress the occurrence of a situation in which the inspection is executed without being ready for the inspection of the inspection image due to an abnormal state in the process of generating a reference image.

### <Specific Example of Predetermined State in Process of Generating Reference Image>

### [Reserving of First Storage and Second Storage]

Examples of the predetermined state in the process of generating a reference image include a state in which the first storage cannot be reserved in the image memory 314. The controller 310 can be configured not to perform the inspection by the image inspector 350 when the first storage cannot be reserved in the image memory 314. Thus, it is possible to prevent or suppress the occurrence of a situation in which the inspection is performed without being able to store the generated reference image in the image memory 314. The controller 310 compares, for example, the remaining capacity of the image memory 314 that can be used to store the reference image with the expected size of the reference image. When the remaining capacity of the image memory 314 is equal to or more than the expected size of the reference image, the controller 310 determines that the first storage can be reserved in the image memory 314. On the other hand, when the remaining capacity of the image memory 314 is less than the size of the reference image, the controller 310 determines that the first storage cannot be reserved in the image memory 314.

Examples of the predetermined state in the process of generating a reference image also include a state in which the second storage cannot be reserved in the image memory 314. The controller 310 can be configured not to perform the inspection by the image inspector 350 when the second storage cannot be reserved in the image memory 314. Thus, it is possible to prevent or suppress the occurrence of a situation in which the inspection is performed without being able to store the generated read image. The controller 310 compares, for example, the remaining capacity of the image memory 314 that can be used to store the read image with the expected size of the read image. When the remaining capacity of the image memory 314 is equal to or more than the expected size of the read image, the controller 310 determines that the second storage can be reserved in the image memory 314. On the other hand, when the remaining capacity of the image memory 314 is less than the size of the read image, the controller 310 determines that the second storage cannot be reserved in the image memory 314.

### [Generation of Reference Image]

Examples of the predetermined state in the process of generating a reference image also include a state in which the status of generation of the reference image does not satisfy a predetermined status. The process of generating a reference image can include a process of determining whether or not a status of generation of the reference image by the reference image generator 380 satisfies a predetermined status. The controller 310 can be configured not to perform the inspection by the image inspector 350 when the status of generation of the reference image does not satisfy a predetermined status as the predetermined state. The situation in which the status of generation of the reference image does not satisfy the predetermined status can be, for example, a status in which the reference image has not been generated, a status in which the percentage of the reference image that has been generated at a certain time point in the process of generating a reference image is less than a predetermined percentage, or a status in which the generation speed of the reference image is less than a predetermined speed. In a case where the generation of the reference image is continued in a situation in which the percentage of the reference image that has been generated at a certain time point in the process of generating a reference image is less than a predetermined percentage or in a situation in which the generation speed of the reference image is less than a predetermined speed, it is expected that the reference image is not generated before the inspection of the inspection image. If it is expected that the reference image will not be generated before the inspection of the inspection image, the controller 310 can cause the image inspector 350 not to perform the inspection.

### [Storage of Reference Image in First Storage]

Examples of the predetermined state in the process of generating a reference image also include a state in which the reference image is not stored in the first storage. The process of generating a reference image can include a process of determining whether or not the reference image generated by the reference image generator 380 is stored in the first storage. The controller 310 can be configured not to perform the inspection by the image inspector 350 when the reference image is not stored in the first storage.

### [Transmission of Reference Image to First Storage]

Examples of the predetermined state in the process of generating a reference image also include a state in which the document image (page image) for each page based on the print job is not transmitted to the first storage. The process of generating a reference image can include a process of transmitting a page image based on the print job to the first storage. The controller 310 can be configured not to perform the inspection by the image inspector 350 when the page image based on the print job is not transmitted to the first storage.

### [Deletion of Reference Image and Read Image]

Examples of the predetermined state in the process of generating a reference image also include a state in which the reference image corresponding to the previously inspected inspection image is not deleted. The process of generating a reference image can include a process of deleting the reference image stored in the first storage. For example, the controller 310 can be configured not to perform the inspection by the image inspector 350 when the reference image based on the j-th page (second page) is not deleted from the first storage before the inspection of the k-th page (first page) by the image inspector 350. The j-th page is a page inspected by the image inspector 350 before the k-th page. The j-th page may be an immediately preceding page of the k-th page. Alternatively, the j-th page may be the oldest page among the pages stored in the first storage.

Examples of the predetermined state in the process of generating a reference image also include a state in which the read image corresponding to the previously inspected inspection image is not deleted. The process of generating a reference image can include a process of deleting the read image stored in the second storage. For example, the controller 310 can be configured not to perform the inspection by the image inspector 350 when the read image based on the j-th page (second page) is not deleted from the second storage before the inspection of the k-th page (first page) by the image inspector 350. The j-th page is a page inspected by the image inspector 350 before the k-th page. The j-th page may be an immediately preceding page of the k-th page. Alternatively, the j-th page may be the oldest page among the pages stored in the second storage.

### <Print Job>

As described above, the image forming system 300 receives a print job, and generates a reference image and forms an inspection image in parallel in a case where the inspection setting of job information is on. The controller 310 and the print controller 320 perform control such that the generation of the reference image by the reference image generator 380 and the formation of the inspection image by the image former 330 are performed in parallel in one (same) print job.

On the other hand, the image forming system 300 may perform the generation of the reference image and the formation and inspection of the inspection image according to separate print jobs. The controller 310 and the print controller 320 perform control so that the reference image generation process (reference image generation job) and the inspection process (inspection job) are performed in parallel. Here, the reference image generation process includes generating a reference image by the reference image generator 380. The inspection process includes forming an inspection image on a sheet by the image former 330 and inspecting, by the image inspector 350, a read image generated by reading the sheet on which the inspection image has been formed. For example, the reference image generation process can be performed by a CPU different from the image control CPU 311, and the inspection process can be performed by the image control CPU 311. Alternatively, when the controller 310 includes a multi-core CPU, the reference image generation process and the inspection process may be assigned to different cores, and may be performed in parallel by these cores.

The image inspection system, the image inspection apparatus, the image inspection method, and the image inspection program have been described above in the embodiment. However, it is obvious that those skilled in the art can appropriately make addition, modifications, and omissions with respect to the present invention within the scope of the technical idea thereof.

For example, the above embodiment has described the case where the controller 310 has a function of instructing the reference image generator 380 to generate a reference image, but the present invention is not limited to such a case. For example, the scanner controller 342 or the image inspection controller 351 may be configured to have a function of instructing the reference image generator 380 to generate a reference image. Further, the reference image generator 380 may be mounted on the image reader 340 or the image inspector 350.

The above-described embodiment has described the case in which the first storage and the second storage are reserved in the image memory 314 of the controller 310, but the present invention is not limited thereto. For example, the first storage and the second storage may be reserved in a memory in the scanner controller 342 or the image inspection controller 351. For example, the image inspector 350 can be configured such that the image inspection controller 351 functions as an image acquirer that acquires the reference image and the read image, and the reference image and the read image are stored in a first storage and a second storage reserved in the image inspection controller 351, respectively. The image inspector 350 can also function as an image inspection apparatus alone by inspecting the read image stored in the second storage based on the reference image stored in the first storage.

In addition, although the above embodiment has described the case of generating a document image based on a print job, the present invention is not limited to such a case. The image former 330 may include an image reading device 333 (see FIG. 1) that reads a document prepared by a user, and may be configured to generate a document image based on an image generated by reading the document by the image reading device 333. The image reading device 333 reads, for example, a document conveyed to a predetermined reading position by an automatic document feeder using a scanner, and generates image data.

Furthermore, the image inspection program may be provided by a computer-readable recording medium, such as a USB memory, a flexible disk, or a CD-ROM, or may be provided online via a network, such as the Internet. In this case, the program recorded on the computer-readable recording medium is usually transferred to and stored in a memory, a storage, or the like. Alternatively, the image inspection program may be provided, for example, as independent application software, or may be incorporated into software of each device as a function of a server.

Furthermore, a part or a whole of the processing performed by the image inspection program in the embodiment can be performed in the form of hardware such as circuits.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection system comprising
a hardware processor that generates a reference image to be used for inspecting an image formed on a recording medium and performs inspection of an inspection target image generated by reading the image formed on the recording medium on the basis of the reference image,
wherein the hardware processor controls not to perform the inspection on the basis of a predetermined state occurring in a process of generating the reference image.

2. The image inspection system according to claim 1, wherein the hardware processor performs control so that the process of generating the reference image and an inspection process of inspecting the image are executed in parallel.

3. The image inspection system according to claim 1, further comprising a first storage that stores a reference image to be generated, wherein
the process of generating the reference image includes a process of reserving the first storage in a storage device, and
the hardware processor does not perform the inspection when the first storage is unable to be reserved as the predetermined state.

4. The image inspection system according to claim 1, wherein
the process of generating the reference image includes a process of determining whether or not a status of generation of a reference image to be generated satisfies a predetermined status, and
the hardware processor does not perform the inspection when the status of generation of the reference image does not satisfy the predetermined status as the predetermined state.

5. The image inspection system according to claim 1, further comprising a first storage that stores a reference image to be generated, wherein
the process of generating the reference image includes a process of determining whether or not the generated reference image is stored in the first storage, and
the hardware processor does not perform the inspection when the reference image is not stored in the first storage as the predetermined state.

6. The image inspection system according to claim 1, further comprising a first storage that stores a reference image to be generated, wherein
the hardware processor acquires a job for forming the image on the recording medium,
the process of generating the reference image includes a process of transmitting a page image based on the job to the first storage, and
the hardware processor does not perform the inspection when the page image based on the job is not transmitted to the first storage as the predetermined state.

7. The image inspection system according to claim 1, further comprising a first storage that stores a reference image to be generated, wherein
the process of generating the reference image includes a process of deleting the reference image stored in the first storage, and
the hardware processor does not perform the inspection when, as the predetermined state, the reference image based on a second page that has been subjected to the inspection prior to the inspection of a first page is not deleted from the first storage before the inspection of the first page.

8. An image inspection apparatus comprising
a hardware processor acquiring a reference image that is to be used for inspecting an image formed on a recording medium and that has been generated and an inspection target image generated by reading the image formed on the recording medium, the hardware processor performing inspection of the inspection target image on the basis of the reference image,
wherein the hardware processor controls not to perform the inspection on the basis of a predetermined state occurring in a process of generating the reference image.

9. An image inspection method comprising:
generating a reference image to be used for inspecting an image formed on a recording medium; and
performing inspection of an inspection target image generated by reading the image formed on the recording medium on the basis of the reference image,
wherein the inspection is not performed on the basis of a predetermined state occurring in a process of generating the reference image.

10. A non-transitory computer-readable recording medium storing an image inspection program for causing a computer to execute processing comprising:
generating a reference image to be used for inspecting an image formed on a recording medium; and
performing inspection of an inspection target image generated by reading the image formed on the recording medium on the basis of the reference image,
wherein the inspection is not performed on the basis of a predetermined state occurring in a process of generating the reference image.
